(19) United States
(12) Patent Application Publication
(10) Pub. No.: US 2005/0070173 A1
(43) Pub. Date: Mar. 31, 2005

(54) Pogo type antenna connector

(76) Inventors: Qisheng Zheng, Kunsan (CN); Shaoping Du, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/951,485

(22) Filed: Sep. 27, 2004

(30) Foreign Application Priority Data
Sep. 26, 2003 (TW) 92217365

(51) Int. Cl. H01R 13/24

(52) U.S. Cl. 439/824

(57) ABSTRACT

An electrical connector includes a first dielectric housing (1), a second dielectric housing (2) mating with the first dielectric housing, a contact terminal (3) normally upwardly projecting beyond the first housing, a retaining terminal (5) for being fixed on a printed circuit board and a compression spring (4) positioned between the contact terminal and the retaining terminal. The first housing has a first hole (100). The second housing has a second hole (200) cooperating with the first hole to define a receiving space for receiving the contact terminal, the spring terminal and the retaining terminal. The first housing defines a recess (14) adjacent to the first hole and a latching arm (13) extends from the recess. The second housing has a latching slot (24) adjacent to the second hole for elastically engaging with the latching arms, thereby removable locking with the first housing.

### BACKGROUND OF THE INVENTION

1. Field of the Invention

The present invention relates to an electrical connector and more particularly, to a pogo type electrical connector for being mounted on a printed circuit board or the like and for connecting an antenna or the like to the printed circuit board.

2. Description of the Prior Art

Electrical connectors are usually mounted on a printed circuit board as a component of a contact device. U.S. Patent application Publication No. 2002/0160637 discloses a conventional spring connector. The spring connector is constituted by an insulative holder unitarily molded in a one-piece structure formed with a plurality of through holes, a pair of bottom conductive terminals normally downwardly projecting beyond the through holes, top conductive pins slidable with respect to the holder and normally upwardly projecting beyond the through holes and middle coiled springs positioned between the terminals and the pins. The holder defines a plurality of grooves communicating with lower end of a corresponding through hole. The terminal has a plurality of triangle-shaped engagement projections at bottom side portions thereof engaging with the grooves for locking with the holder, thereby being securely fixed in the holder.

However, the terminal having the triangle-shaped engagement projections has a larger width than the diameter of the hole. Therefore the terminal cannot be conveniently extracted after being mounted in the holder. In fact, the extraction of the mounted terminal inevitably cracks the hole wall or the terminal. Since the holder is unitarily molded in a one-piece structure and the terminals cannot be exchanged, even a single inferior terminal can cause the whole to be wasted. This is economically inefficient, indeed.

Hence, an electrical connector with improved housing is needed to overcome the forgoing shortcomings.

### BRIEF SUMMARY OF THE INVENTION

It is an object of the present invention is to provide an electrical connector having first and second dielectric housings mating with each other capable of obviating the above-mentioned problems.

An electrical connector includes a first dielectric housing, a second dielectric housing mating with the first dielectric housing, a top contact terminal normally upwardly projecting beyond the first housing, a bottom retaining terminal for being fixed on a printed circuit board and a middle coiled spring positioned between the contact terminal and the retaining terminal. The first housing has a first hole and the second housing has a second hole cooperating with the first hole to define a receiving space for receiving the contact terminal, the spring terminal and the retaining terminal. The first housing has a pair of latching arms and the second housing has a pair of latching slots for elastically engaging with the latching arms, thereby removable locking the first housing.

Owing to the structural arrangement, the contact terminal, the coiled spring and the retaining terminal can be freely removed from the first and second housing or replaced again into the first and second housing with ease.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a perspective view of an electrical connector according to the present invention;

FIG. 2 is another perspective view of the electrical connector;

FIG. 3 is an explode view of FIG. 1; and

FIG. 4 is an explode view of FIG. 2.

### DETAILED DESCRIPTION OF THE PREFERRED EMBODIMENT

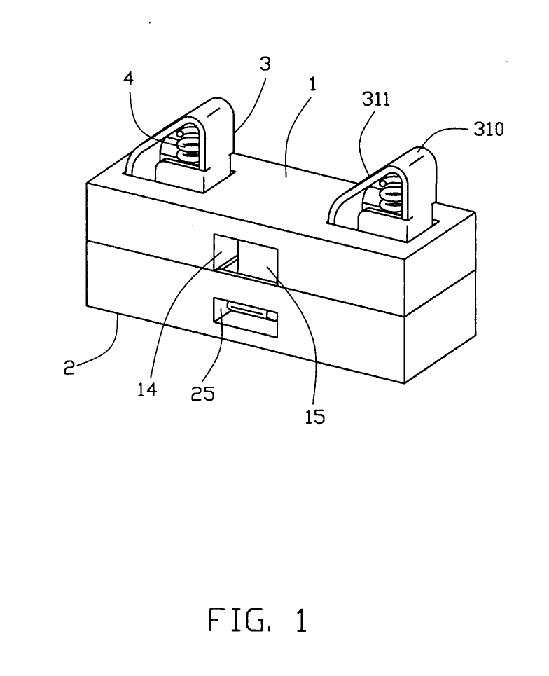

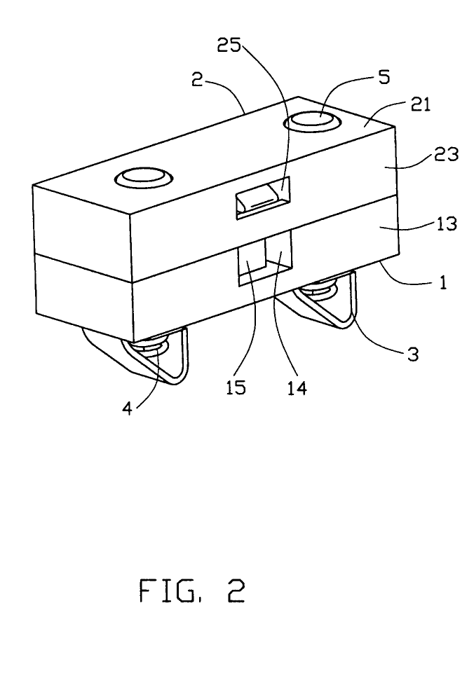

Referring to FIGS. 1 and 2, an electrical connector in accordance with the present invention includes a two-parts constructive casing consisting a first dielectric housing 1 and a second dielectric housing 2 mating with the first housing 1 and a pair of contact terminals 3, spring terminals 4 and retaining terminals 5 mounted in the assembled housings 1 and 2.

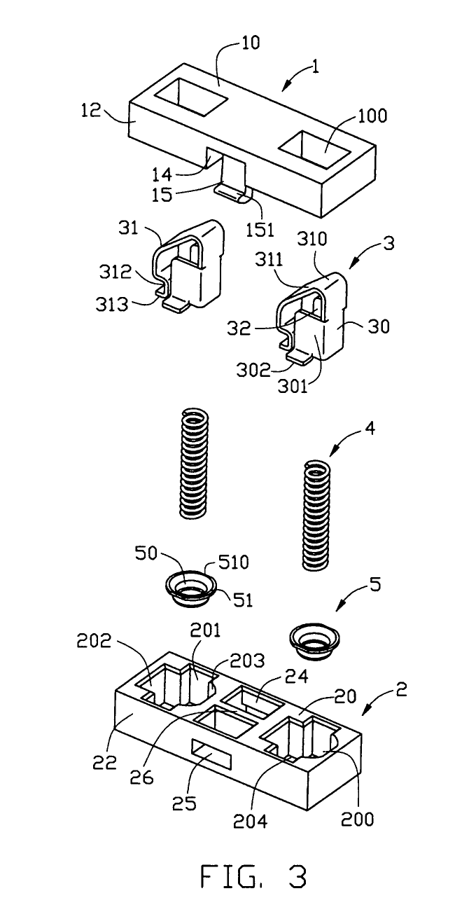

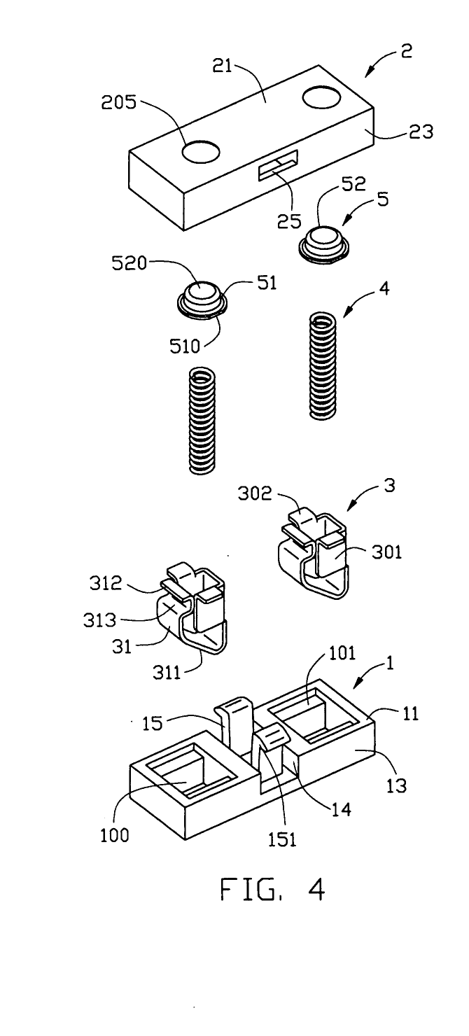

Referring to FIGS. 3 and 4 in conjunction with FIGS. 1 and 2, the first housing 1 has a substantially rectangle-shaped configuration and includes an upper face 10, a lower face 11, a first front face 12 and a first rear face 13. A pair of first holes 100 are defined through the upper and the lower faces 10, 11 and are adjacent to side walls (not labeled) of the first housing 1. Each first hole 100 symmetrically forms a pair of generally blocks 101 projecting into the first holes 100. Each block 101 has a bottom surface higher than the lower face 11. A downwardly exposed recess 14 is defined through a middle of opposite fist front and rear faces 12, 13. A pair of latching arms 15 extend downwardly and perpendicularly into the recess 14 and project beyond the recess 14. The latching arms 15 are arranged in parallel to each other and are adjacent to corresponding first front and rear faces 12, 13. Each latching arm 15 has a hook-shaped latching shoulder 151. The latching shoulder 151 perpendicularly and outwardly extends from a distal end of the latching arm 15 and projects toward the corresponding first front and rear faces 12, 13.

The second housing 2 has a substantially rectangle-shaped configuration cooperating with the first housing 1. The second housing 2 includes a top face 20 mating to the lower face 11 of the first housing 1, a bottom face 21, a second front face 22 and a second rear face 23. A pair of second holes 200 are arranged at each side of the second housing 1 corresponding to the first holes 100 of the first housing 1. A pair of opposite U-shaped slots 201 are defined communicating with the second holes 200 and are adjacent to corresponding second front and rear faces 22, 23. A guiding slot 202 and an arch slot 203 oppositely communicate with the second holes 200. The second housing 2 has a bottom plate 204 covering a lower end of the second holes 200. A round hole 205 is defined at the bottom plate 204 and communicates with a corresponding hole 200. A pair of latching slots 24 are defined at a middle of the top face 20 of the second housing 2 and are adjacent to corresponding second front face 22 and the second rear face 23 for mating with the latching arms 15 of the first housing 1. An interlayer 26 is parallel to the second front face 22 and the second rear face 23 and stands between the latching slots 24. An opening 25 is defined in a corresponding front/rear face 22/23 for cooperating with a corresponding latching shoulder 151 of the latching arm 15. The latching slots 24 and the openings 25 communicate with each other and are perpendicular to each other.

The contact terminals 3 are stamped and each includes a substantially rectangular body portion 30 and a cantilevered beam 31 downwardly and diagonally extending from a top portion of the body portion 30, thereby having a substantially V-shaped configuration. The body portion 30 has a pair of wings 301 perpendicularly bending toward the cantilevered beam 31 from opposite side edges thereof. A receiving room 32 is defined by the body portion 30, the wings 301 and the cantilevered beam 31. Each wing 301 has a flange 302 outwardly and transversely extending from a bottom edge thereof for abutting against the blocks 101 the first housing 1 and running through the pair of U-shaped slots 201 of the second housing 2. The contact terminal 3 has an upwardly projecting contact portion 310 on a top portion thereof for interconnecting the body portion 30 and the cantilevered beam 31. The cantilevered beam 31 comprises an outer leading face 311 extending downwardly and angularly from the contact portion 310. A mating electrical device (not shown) can electrically connect with the contact portion 310 through the leading face 311. The cantilevered beam 31 further has an engaging portion 312 downwardly extending from a bottom end of the leading face 311. The engaging portion 312 is of a generally U-shaped and projects inwardly to the body portion 30. The U-shaped engaging portion 312 has a horizontal extending retaining portion 313 on a lower portion thereof for retaining against inner surface of guide slot 202 of the first housing 1.

The retaining terminal 5 has a substantially dome-shaped portion (not labeled) downwardly stamped from a substantially central portion thereof. The dome-shaped portion comprises an upwardly exposed retaining cavity 50 for receiving a lower end of the spring terminal 4 and a soldering nod 520 on a lower surface thereof for soldering to a printed circuit board (PCB, not shown). The retaining terminal 5 has a horizontally extending mounting flange 51 surrounding an outer periphery of the dome-shaped portion. The mounting flange 51 is generally round-shaped configuration with a pair of straight sides 510 cutting from opposite sides thereof being received in the U-shaped slots 201 of the second housing 2.

The spring terminals 4 are coiled springs in the present invention and positioned between the contact terminals 3 and the retaining terminals 5. The spring terminal 4 comprises an upper end received in the receiving room 32 of the contact terminal 3.

Referring to FIGS. 1 to 4, in assembly, the retaining terminals 5 are installed into the second through holes 200 from the top face 20 of the housing 2 with the dome-shaped portion protruding beyond the bottom face 21. The mounting flanges 51 of the retaining terminals 5 engage with corresponding bottom plates 204. The straight sides 510 engage with the U-shaped slots 201 for preventing the retaining terminals 5 from slipping. The dome-shaped portions protrude beyond the bottom face 21 through the round holes 205 of the second housing 2. Then the contact terminals 3 are mounted to the first housing 1 from bottom of the first holes 100. The leading faces 311 of the contact terminals 3 project beyond the upper face 10 of the first housing 1. The flanges 302 of the wings 301 of the contact terminals 3 respectively abut against the bottom surface of the blocks 101 of the first housing 1. The spring terminals 4 enter into the second holes 200 with the lower ends extending into the retaining cavity 50 of corresponding retaining terminals 5 and the upper ends extending into the receiving rooms 32 of the contact terminals 3. Finally the first housing 1 is assembled to the second housing 2. The pair of latching arms 15 of the first housing 1 enter into the latching slots 24 of the second housing 2 and the interlayer 26 of the second housing 2 is positioned between the latching arms 24. The latching shoulders 151 of the latching arms 15 elastically latch with corresponding tranverse openings 25 for securable interconnection between the first housing 1 and the second housing 2. The lower face 11 of the first housing 1 intimately cooperates with the top face 20 of the second housing 2.

It should be noted that the contact terminals 3, the spring terminals 4 and the retaining terminals 5 can be freely removed from or inserted again into the electrical connector with ease. Depressing the latching arms 15 inwardly through the recess 14 of the first housing 1, the latching arms 15 urge corresponding latching shoulders 151 to move inwardly, thereby disengaging the latching shoulders 151 from the counterpart openings 25 of the second housing 2 and releasing the fist housing 1 from the second housing 2. Therefore, it is easy and convenient for users to exchange the contact terminals 3 or the spring terminals 4 or the retaining terminals 5 or what they want.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

1. An electrical connector adapted for being mounted on a printed circuit board as a contact device, comprising:
a casing including a first dielectric housing and a second dielectric housing mating with the first dielectric housing, the first housing defining a first hole, the second housing defining a second hole mating with the first hole defining a receiving space, the first housing defining a recess adjacent to the first hole and a latching arm extending from the recess, the second housing having latching slot engaged with the latching arm adjacent to the second engaged with the latching arm; and
a contact terminal, a spring terminal and a retaining terminal mounted in the receiving space of the casing, the contact terminal normally upwardly projecting beyond the first housing, the retaining terminal being fixed on the printed circuit board, the spring terminal being compressed between the contact terminal and the retaining terminal to provide the contact terminal with flexibility.

2. The electrical connector according to claim 1, wherein the second housing defines an opening communicating with the latching slot, and wherein the latching arm has a latching shoulder projecting into the opening and substantially perpendicularly extending for securely and elastically locking the first housing with the second housing.

3. The electrical connector according to claim 1, wherein the contact terminal has a flange outwardly and transversely bending from a bottom end thereof, and wherein the first housing defines a block at a bottom thereof, the flange abutting against the block.

4. The electrical connector according to claim 1, wherein the second housing has a bottom plate, the bottom plate defining a round hole communicating with a lower end of the second hole, and wherein the retaining terminal includes a dome-shaped portion protruding beyond the bottom plate through the round hole and a horizontally extending mounting flange surrounding an outer periphery of the dome-shaped portion, the horizontally extending mounting flange engaging with the bottom plate.

5. The electrical connector according to claim 4, wherein the mounting flange is of generally round-shaped and has a pair of straight sides cutting from opposite sides thereof being received with the second hole.

6. An electrical connector adapted for being mounted on a printed circuit board as a contact device, comprising:
a casing including a first dielectric housing and a second dielectric housing mating with the first dielectric housing, the first housing defining a first hole, the second housing defining a second hole mating with the first hole defining a receiving space; and
a resilient conductive terminal mounted in the receiving space of the casing.

7. The electrical connector according to claim 6, wherein means for securing the first housing to the second housing is provided on the first housing and on the second housing.

8. The electrical connector according to claim 7, wherein the means includes a latching arm extending from the first housing adjacent to the first hole and a latching slot defined in the second housing so that the latching arm engaged with the latching slot.

9. The electrical connector according to claim 6, wherein the resilient conductive terminal including a contact terminal, a spring terminal and a retaining terminal, the contact terminal normally upwardly projecting beyond the first housing, the retaining terminal being fixed on the printed circuit board and the spring terminal being compressed between the contact terminal and the retaining terminal to provide the contact terminal with flexibility.

10. An electrical connector comprising:
a casing including discrete first and second insulative housings retainably stacked with each other, the first housing defining a first through hole, the second housing defining a second through hole;
a contact terminal disposed in the first through hole, a retaining terminal disposed in the second through hole; and
a biasing device urging said contact terminal and said retaining terminal away from each other in a stacked direction of said first and second housings; wherein
the retaining terminal defines a mounting tip exposed out of the mounting face of the second housing with a relatively small distance, while the contact terminal defines a contact tip exposed out of the contact face of the first housing with a relatively large distance and with a slanted guidance face thereof.

11. The electrical connector according to claim 10, wherein said first hole is aligned with the second hole.

12. The electrical connector according to claim 10, wherein said contact terminal is constantly engaged with the retaining terminal when said contact terminal is moveable relative to the retaining terminal in the first hole along the stacked direction.
